(19) United States
(12) Patent Application Publication
(10) Pub. No.: US 2013/0159291 A1
(43) Pub. Date: Jun. 20, 2013

(54) RANKING SEARCH RESULTS USING WEIGHTED TOPOLOGIES

(71) Applicants: Samuel Ieong, Mountain View, CA (US); Nina Mishra, Pleasanton, CA (US); Or Sheffet, Pittsburgh, PA (US)

(72) Inventors: Samuel Ieong, Mountain View, CA (US); Nina Mishra, Pleasanton, CA (US); Or Sheffet, Pittsburgh, PA (US)

(73) Assignee: Microsoft Corporation, Redmond, WA (US)

(21) Appl. No.: 13/325,081

(22) Filed: Dec. 14, 2011

(51) Int. Cl. G06F 17/30

(52) U.S. Cl. 707/723; 707/E17.084

(57) ABSTRACT

Identifiers of items generated in response to a query are each ranked in a way that considers the other identified items. Topologies are generated that correspond to features of the identified items. Each topology may be a Markov chain that includes a node for each identified item and directed edges between the nodes. Each directed edge between a node pair has an associated transition probability that represents the likelihood that a hypothetical user would change their preference from a first node in the pair to the second node in the pair when considering the feature associated with the topology. The topologies are weighted according to the relative importance of the features that correspond to the topologies. The weighted topologies are used to generate a stationary distribution of the identified items, and the identified items are ranked using the stationary distribution.

### BACKGROUND

A common way to rank search results (e.g., URLs) in modern search engines is to use ranking functions. These functions take as an input a URL and the query that was used to select the URL, and output a score for the URL. Each URL in a set of search results is given a score, and the search results are ranked according to the scores. The score given to a URL is independent of the other URLs in the search results.

One problem associated with such ranking techniques is that it is assumed that a user's preference for a URL in a set of search results is independent of the other URLs presented in the set. In reality, a user's preference for a URL is dependent on the other URLs in the search results.

For example, a user may submit the query “paper shredder” when searching for a paper shredder. If the user is presented with a URL corresponding to A, a $20 7-sheet capacity shredder, and a URL corresponding to B, a $50 11-sheet capacity shredder, the user may prefer A to B. However, if the user is also presented a URL corresponding to C, a $95 11-sheet capacity shredder, the user may now prefer B to A. The user's preference between A or B is dependent on whether or not the user is also presented with C.

Thus, by ranking each search result independently from the other search results, the rankings may not accurately reflect user preferences and may cause a poor search experience for users.

### SUMMARY

Identifiers of items generated in response to a query are each ranked in a way that considers the other identified items. Topologies are generated that correspond to features of the identified items. Each topology may be a Markov chain that includes a node for each identified item and directed edges between the nodes. Each directed edge between a node pair has an associated transition probability that represents the likelihood that a hypothetical user would change their preference from a first node in the pair to the second node in the pair when considering the feature associated with the topology. The topologies are weighted according to the relative importance of the features that correspond to the topologies. The weighted topologies are used to generate a stationary distribution of the identified items, and the identified items are ranked using the stationary distribution.

In an implementation, a plurality of identifiers of items is received. Each item is associated with a plurality of feature values and each feature value is associated with a feature of a plurality of features. A plurality of topologies is generated, and each topology corresponds to a feature of the plurality of features and each topology includes transition probabilities between items for the feature values of the feature corresponding to the topology. A weight is received for each of the generated topologies. The plurality of identifiers of items is ranked using the generated topologies and the retrieved weights. The ranked identifiers of items are provided, e.g. to a display, storage, or a computing device.

In an implementation, a plurality of topologies is received at a computing device. Each topology corresponds to a feature of a plurality of items. A weight is generated for each topology at the computing device. A search log is received at the computing device. The search log includes queries and identifiers of items selected from a results set presented in response to each query. A first distribution of the items selected in the search log is computed by the computing device. A second distribution of the items using the weighted topologies is computed by the computing device. The first and the second distributions are compared by the computing device. One or more of the generated weights are adjusted based on the comparison by the computing device. The generated weights are provided by the computing device.

This summary is provided to introduce a selection of concepts in a simplified form that are further described below in the detailed description. This summary is not intended to identify key features or essential features of the claimed subject matter, nor is it intended to be used to limit the scope of the claimed subject matter.

### BRIEF DESCRIPTION OF THE DRAWINGS

The foregoing summary, as well as the following detailed description of illustrative embodiments, is better understood when read in conjunction with the appended drawings. For the purpose of illustrating the embodiments, there is shown in the drawings example constructions of the embodiments; however, the embodiments are not limited to the specific methods and instrumentalities disclosed. In the drawings:

FIG. 1 is an illustration of an example environment for ranking identifiers of items;

FIG. 2 is an illustration of an example topology;

FIG. 3 is another illustration of an example topology;

FIG. 4 is an illustration of an example ranker;

FIG. 5 is an operational flow of an implementation of a method for ranking identified items;

FIG. 6 is an operational flow of an implementation of a method for generating weights for topologies; and

FIG. 7 shows an exemplary computing environment in which example embodiments and aspects may be implemented.

### DETAILED DESCRIPTION

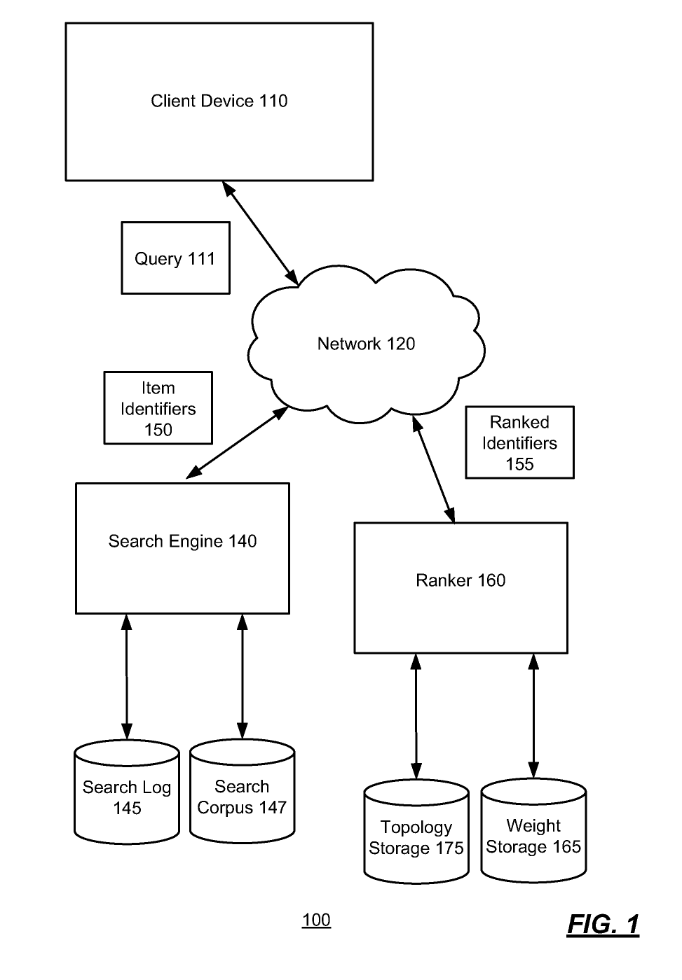

FIG. 1 is an illustration of an example environment 100 for ranking identifiers of items. A client device 110 may communicate with one or more search engines 140 through a network 120. The client device 110 may be configured to communicate with the search engines 140 to access, receive, retrieve, and display media content and other information such as webpages. The network 120 may be a variety of network types including the public switched telephone network (PSTN), a cellular telephone network, and a packet switched network (e.g., the Internet).

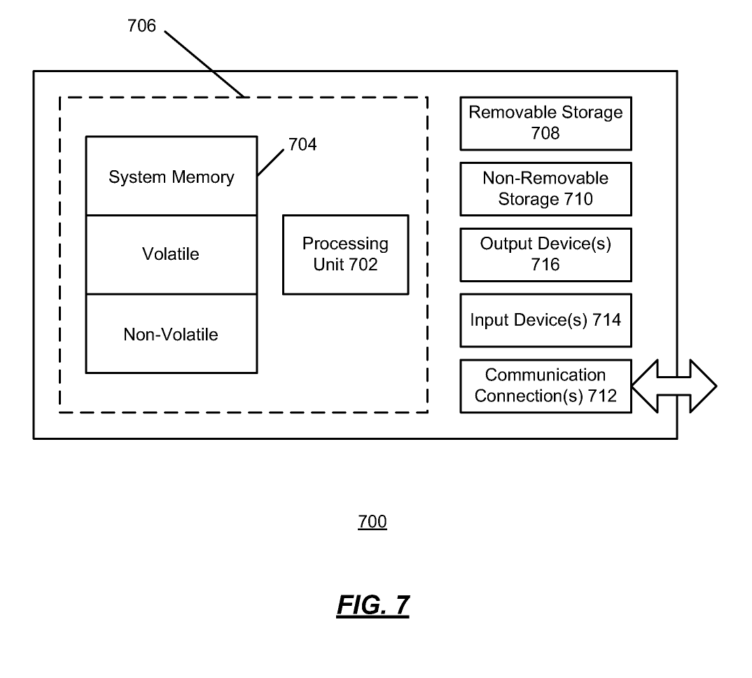

In some implementations, the client device 110 may include a desktop personal computer, workstation, laptop, PDA, smart phone, cell phone, or any WAP-enabled device or any other computing device capable of interfacing directly or indirectly with the network 120. The client device 110 may run an HTTP client, e.g., a browsing program, such as MICROSOFT INTERNET EXPLORER or other browser, or a WAP-enabled browser in the case of a cell phone, PDA or other wireless device, or the like, allowing a user of the client device 110 to access, process, and view information and pages available to it from the search engine 140. The client device 110 may be implemented using a general purpose computing device such as the computing device 700 illustrated in FIG. 7, for example.

The search engine 140 may be configured to receive queries, such as a query 111, from users using clients such as the client device 110. The search engien 140 may search for media responsive to the query 111 by searching a search corpus 147 using the received query. The search corpus 147 may comprise an index of media such as webpages, product descriptions, image data, video data, map data, etc. In some implementations, the search engien 140 may search for identifiers of items that are responsive to the query 111. The items may include consumer products, hotel or travel reservations, and services, for example. Other items may also be supported.

For example, the search engien 140 may allow users to submit a query 111 for consumer products, and may provide links to consumer products that match the query 111. The search engien 140 may generate and return a set of item identifiers 150 to the client device 110 using the search corpus 147. The item identifiers 150 may be links (e.g., URLs) to some or all of the items that are responsive to the query 111. Other types of identifiers of items may be used, such as names of items, images of items, etc.

In some implementations, the search engien 140 may store some or all of the queries that it receives over a period of time as a search log 145. The search log 145 may include a list or set of received queries 111 along with a time that they were received. The search log 145 may further include the item identifiers 150 that were provided to the user associated with each query 111, along with indicators of selection. The indicators of selection may include click information that may indicate the item identifier(s) that the user ultimately selected.

The environment 100 may further include a ranker 160. The ranker 160 may receive the item identifiers 150 from the search engien 140 and may rank or order the item identifiers 150 to form the ranked identifiers 155. Typical search engines 140 rank search results by assigning each search result a score based on its responsiveness to the query 111, and independently of the other search results. In contrast, the ranker 160 may rank each item identifier based on the other item identifiers presented in the item identifiers 150. The ranked identifiers 155 may then be presented to the user who provided the query 111. While the ranker 160 is illustrated separately from the search engine 140, it is contemplated that the ranker 160 may also be implemented as a component of the search engine 140, for example. The items that may be ranked by the ranker 160 may include a variety of items, objects or things such as consumer products, images, books, videos, movies, music, instant answers, people, etc. There is no limit to what may be ranked by the ranker 160.

The ranker 160 may generate the ranked identifiers 155 using one or more topologies. In some implementations, the topologies may be retrieved from a topology storage 175. There may be a topology in the topology storage 175 for each feature of a particular type or category of items. A feature may be a characteristic of the item category and may have one or more feature values. For example, for a category of items that are paper shredders, the features may include weight, price, brand name, material, sheet capacity, and color. Alternatively or additionally, the ranker 160 may dynamically generate a topology given a feature set corresponding to a particular type or category of item.

A topology may be a representation of how a hypothetical user may change their preference among items of an item category for the particular feature corresponding to the topology. In some implementations, a topology may include a node for each item along with directed edges between some of the nodes. Each directed edge may have an associated transition probability. The transition probability associated with a directed edge between a first node and a second node may represent the probability that the hypothetical user would change their preference from the item represented by the first node to the item represented by the second node when considering the feature represented by the topology. In some implementations, a topology may be represented by a Markov chain. However, other types of data structures may be used.

For example, consider the paper shredders A, B, and C having the features of price and sheet capacity described in the following Table 1:

TABLE 1

| Item | Price | Sheet Capacity |
|---|---|---|
| A | $20 | 7 |
| B | $50 | 11 |
| C | $95 | 12 |

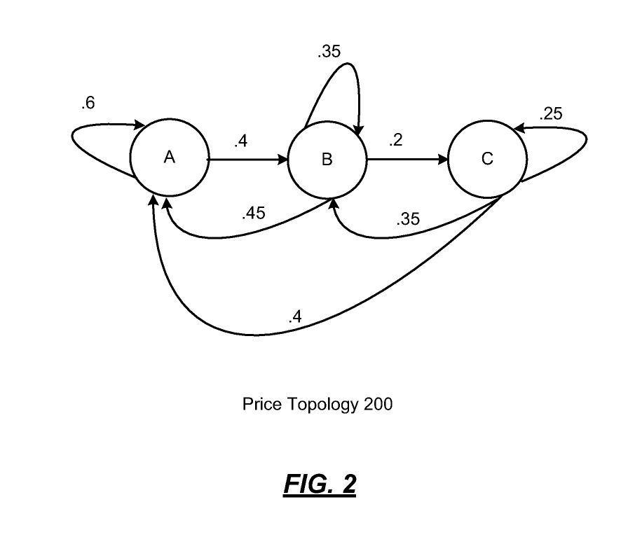

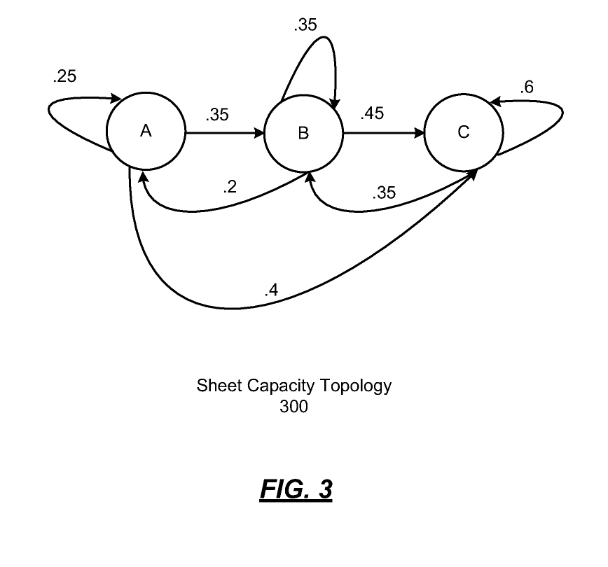

The topologies for the paper shredders A, B, and C described in Table 1 are illustrated respectively in the price topology 200 of FIG. 2 and the sheet capacity topology 300 of FIG. 3. Each topology has a node representing each of the paper shredders A, B, and C, and the directed edge between the nodes is the transition probability that represents the probability that a hypothetical user will change their preference from one item to another when considering the feature corresponding to the topology.

As illustrated by the price topology 200, when considering the feature price, a user who prefers the product A will change their preference to the product B 40% of the time, and will maintain their preference for the product A 60% of the time. A user who prefers the product B will change their preference to the product C 20% of the time, will maintain their preference for the product B 35% of the time, and will change their preference to the product A 45% of the time. A user who prefers the product C will change their preference to the product A 40% of the time, will change their preference to the product B 35% of the time, and will maintain their preference for product C 25% of the time.

As illustrated by the sheet capacity topology 300, when considering the feature sheet capacity, a user who prefers the product A will change their preference to the product B 35% of the time, will maintain their preference for the product A 25% of the time, and will change their preference to the product C40% of the time. A user who prefers the product B will change their preference to the product C 45% of the time, will maintain their preference for the product B 35% of the time, and will change their preference to the product A 20% of the time. A user who prefers the product C will change their preference to the product B 40% of the time, and will maintain their preference for product C 60% of the time.

The topology for each feature and item category may be generated by a user or administrator. For example, the topologies may be generated by observing user purchasing habits. Other methods for generating topologies may be used. The generated topologies may be stored by the ranker 160 in the topology storage 175. In some implementations, topologies may be dynamically generated by the ranker 160 when item identifiers are received by the ranker 160.

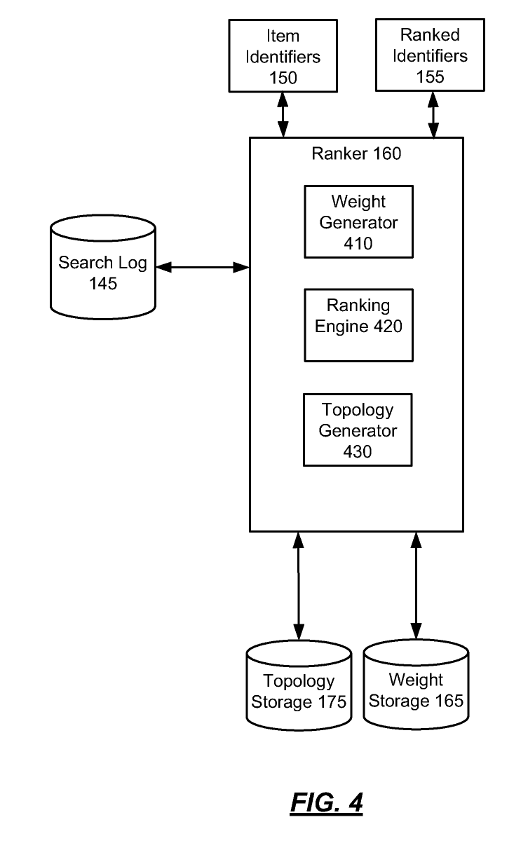

The ranker 160 may generate the ranked identifiers 155 using one or more topologies and one or more weights. In some implementations, there may be a weight in a weight storage 165 for each feature of an item category or type of item. The weights associated with the features may represent the relative importance of each feature for users. Weights associated with more important features may be greater than the weights associated with lesser features. For example, with respect to items that are paper shredders, the feature of price may have a greater weight than the feature of sheet capacity, because users generally find the price feature more important than the sheet capacity feature when considering which paper shredder to purchase. Generation of the weights in the weight storage 165 is described further with respect to FIG. 4. In some implementations, the weights may be generated based on the search log 145 of the search engine 140. In other implementations, the weights may be generated manually using experiments where humans are presented with items having particular features and observing the items and features that the humans prefer. Other methods for generating weights may be used.

The ranker 160 may generate the ranked identifiers 155 from the item identifiers 150 by retrieving topologies from the topology storage 175 that correspond to the features of the identified items. Alternatively or additionally, the ranker 160 may dynamically generate the topologies based on the features of the identified items. The ranker 160 may then retrieve a weight corresponding to each of the topologies from the weight storage 165. The ranker 160 may then generate the ranked identifiers 155 by ranking each of the identified items using the topologies weighted by the retrieved weights.

In some implementations, the ranker 160 may generate the ranked identifiers 155 by computing a stationary distribution of the nodes of the weighted topologies. The frequency of the nodes in the stationary distribution may be used to rank the item identifiers 150. The ranked item identifiers 150 may be provided as the ranked identifiers 155. In some implementations, the stationary distribution may be generated using random walks of the weighted topologies. Other methods may also be used.

FIG. 4 is an illustration of an example ranker, such as the ranker 160. As shown, the ranker 160 may include one or more components including, but not limited to, a weight generator 410, a ranking engine 420, and a topology generator 430. While the components are illustrated as part of the ranker 160, each of the various components may be implemented separately from one another using one or more computing devices such as the computing device 700 illustrated in FIG. 7, for example.

The topology generator 430 may generate topologies corresponding to features of a particular category or type of item. The topology generator 430 may generate the topologies and store the topologies in the topology storage 175. In some implementations, the topology generator 430 may generate the topologies dynamically based on features associated with the received item identifiers 150.

The weight generator 410 may generate a weight corresponding to each topology in a set of topologies. A set of topologies may include topologies corresponding to features of a particular category or type of item. The types of items may include consumer products such as hammers, televisions, digital cameras, or any other types of items, for example.

The weight generator 410 may generate the weights for the topologies in the set of topologies by generating an estimate of each weight. The estimated weights may be random, or may be selected by a user or administrator. In some implementations, the estimated weight for each topology may be set at a default weight. The default weights may be the same for each topology, or may be tailored to the particular topology. For example, topologies associated with a feature related to price may receive a higher default weight than topologies associated with other non-price features.

The weight generator 410 may compute a distribution of items in the search log 145. The search log 145 may include identifiers of selection (e.g., clicks) that identify the item that a user selected for each query. The weight generator 410 may calculate the distribution of items by determining the queries in the search log 145 that are related to the item category or type, and determining the number of times each item was selected when presented in a results set in response to one of the determined queries.

For example, for items that are paper shredders, the weight generator 410 may determine the queries in the search log 145 that are targeted to paper shredders. The weight generator 410 may look for queries with the phrase “paper shredder” or with known synonyms for paper shredders. From those determined queries, the weight generator 410 may determine how many times each paper shredder was selected when presented in a results set generated for one of the queries. The weight generator 410 may look at the indicators of selection in the search log and determine the URL that the user selected, and based on the selected URL, determine the paper shredder (i.e., item) that corresponds to the URL. The weight generator 410 may then generate a distribution of the selected paper shredders among the determined queries in the search log 145.

The weight generator 410 may also compute a stationary distribution of each item in the set of weighted topologies. As described above, each topology may have a plurality of nodes with each node corresponding to an item. In some implementations, the stationary distribution may be computed using single random walks of the set of topologies according to the estimated weights.

The weight generator 410 may further compare the distribution of the items in the search log 145 with the stationary distribution of the items in the weighted topologies, and may adjust one or more of the weights based on the comparison. In some implementations, the weight generator 410 may determine if the difference between the stationary distribution of the weighted topology and the distribution of the items in the search log 145 is less than a threshold difference. If the difference is less than the threshold difference, then the weight generator 410 may determine the weights used for the topologies are acceptable and may be stored in the topology storage 175. The threshold may be selected by a user or administrator, for example.

If the difference is greater than the threshold difference, then the weight generator 410 may adjust the weights used to weight the topologies. In some implementations, the weight generator 410 may adjust the weights by solving an optimization problem using a fundamental matrix. In other implementations, the weights may be randomly adjusted, or adjusted by a fixed or predetermined amount. Any technique for selecting and adjusting weights may be used.

The weight generator 410 may recalculate the stationary distribution of the items in the weighted topologies using the adjusted weights, and compare the recalculated stationary distribution with the previously calculated distribution of the items in the search log 145. The weight generator 410 may continue to adjust the weights, recalculate the stationary distribution of the items in the weighted topologies, and compare the distributions, until the difference between the stationary distribution and the distribution of the items in the search log 145 is below the threshold difference. Once the difference is below the threshold difference, the weight generator 410 may store the generated weights in the weight storage 165.

The ranking engine 420 may use the generated weights and the topologies to generate ranked identifiers 155 from item identifiers 150. The ranking engine 420 may generate the ranked identifiers 155 from the item identifiers 150 by retrieving topologies from the topology storage 175 that correspond to the item identifiers 150. Alternatively or additionally, the ranking engine 420 may use the topology generator 430 to dynamically generate one or more topologies based on the item identifiers 150.

In some implementations, the ranking engine 420 may determine a type or category of item corresponding to the items identified by the item identifiers 150, and may retrieve topologies corresponding to the determined category from the topology storage 175. The type or category of the identified items may be provided to the ranking engine 420, or the ranking engine 420 may determine the type or category of the identified items by processing the item identifiers 150 for key words or other data that may be used to determine the type or category of the identified items.

For example, the ranking engine 420 may determine that the items identified by the item identifiers 150 are digital cameras. The ranking engine 420 may then retrieve topologies that are associated with features of items that are digital cameras from the topology storage 175, or may dynamically generate topologies based on the features of items that are digital cameras. The ranking engine 420 may retrieve or generate topologies associated with features such as megapixels, zoom, price, color, and size, for example.

The ranking engine 420 may retrieve a weight corresponding to each of the retrieved or generated topologies from the weight storage 165. The ranking engine 420 may retrieve the weights generated by the weight generator 410. Continuing the digital camera example, if the ranking engine 420 retrieved or generated topologies corresponding to the features megapixels, price, and zoom, the ranking engine 420 may retrieve the weights associated with the features megapixels, price, and zoom.

The ranking engine 420 may generate the ranked identifiers 155 from the item identifiers 150 by ranking each of the identified items of the item identifiers 150 using the retrieved or generated topologies and the retrieved weights. In some implementations, the ranking engine 420 may rank the identifiers by computing a stationary distribution of nodes of the weighted topologies. The magnitude of a node in the stationary distribution may be used to rank the identified item corresponding to the node. In some implementations, the stationary distribution may be generated using single random walks of the weighted topologies. Other methods may also be used.

In each retrieved or generated topology, there may be nodes and edges corresponding to items that are not identified in the item identifiers 150. For example, the topologies associated with features of digital cameras described above may have nodes and edges corresponding to a large number of known digital cameras. However, only a subset of these items may be identified by the item identifiers 150. Accordingly, before generating the ranked identifiers 155, the ranking engine 420 may remove nodes and edges from each retrieved or generated topology that correspond to an item that is not identified by the item identifiers 150. The modified topologies and the retrieved weights may then be used to generate the ranked identifiers 155.

In some implementations, after removing one or more nodes and edges from a topology, the ranking engine 420 may normalize the transition probabilities of the remaining edges and nodes. As described above, and illustrated in FIGS. 2 and 3, each node in a topology may have one or more directed edges whose total transition probabilities sum to 1. After removing one or more of the nodes and edges, some of the nodes may have associated directed edges with transition probabilities that no longer total to 1. Accordingly, the ranking engine 420 may normalize the transition probabilities of the directed edges for such nodes by increasing the transition probabilities of the remaining directed edges so that the transition probabilities total to 1. Any method or technique for normalizing transition probabilities (e.g., in Markov chains) may be used. The modified normalized topologies and the retrieved weights may then be used to generate the ranked identifiers 155.

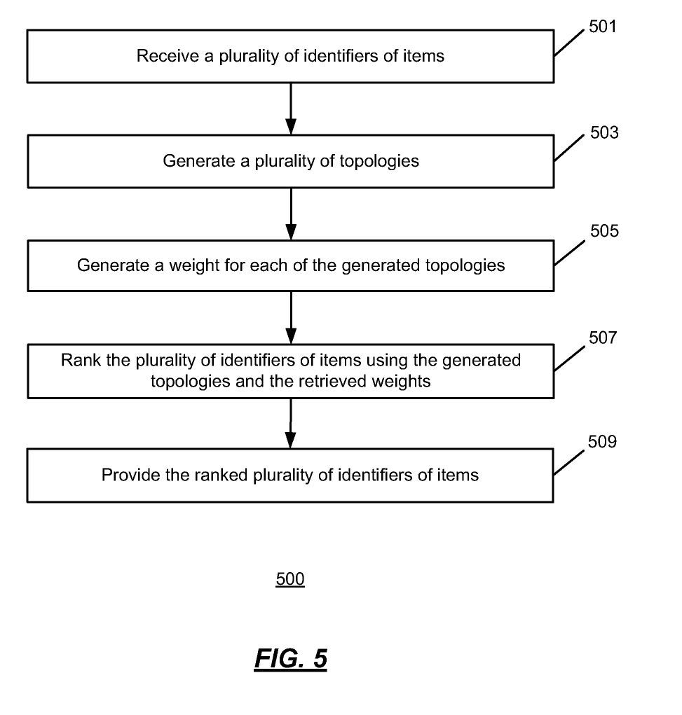

FIG. 5 is an operational flow of an implementation of a method 500 for ranking identified items. The method 500 may be implemented by the ranker 160, for example. A plurality of identifiers of items is received at 501. The plurality of identifiers may be the item identifiers 150, and may be received by the ranker 160 from the search engine 140. The item identifiers 150 may comprise links such as URLs and may have been generated by the search engien 140 in response to a query 111. The query 111 may be a query for information related to an item such as a consumer product, for example.

In some implementations, each identified item may be associated with a plurality of feature values corresponding to a plurality of features. For example, where the identified items are televisions, each item may have a feature value corresponding to features such as screen size, resolution, and brand.

A plurality of topologies is generated at 503. The pluralities of topologies may be generated by the topology generator 430. Alternatively, the plurality of topologies may be retrieved by the ranker 160 from the topology storage 175. Each of the topologies may correspond to a feature of the plurality of features associated with the plurality of identifiers of items.

In some implementations, each topology may include a plurality of nodes that each represent an item, and the nodes may be connected to each other by one or more directed edges. Each directed edge between nodes may have an associated transition probability that represents the likelihood that a hypothetical user will change their preference between the items represented by the nodes based on the feature associated with the topology. In an implementation, the topologies may comprise Markov chains.

A weight for each of the topologies is generated and/or retrieved at 505. The weights may be retrieved by the ranking engine 420 of the ranker 160 from the weight storage 165. Each weight may correspond to a topology and may be a measure of the importance of the feature associated with its corresponding topology. The weights may have been generated by the weight generator 410 of the ranker 160 from a search log 145. Other methods for generating weights may be used.

The plurality of item identifiers is ranked using the plurality of topologies and the retrieved weights at 507. The plurality of item identifiers may be ranked by the ranking engine 420 of the ranker 160. In some implementations, the identifiers of items may be ranked by computing a stationary distribution of the nodes of the weighted topologies. The identifiers of items may be ranked according to the stationary distribution of the nodes corresponding to the identified items.

The ranked plurality of identifiers of items is provided at 509. The ranked plurality of identifiers of items may be provided as the ranked identifiers 155 to the search engien 140 or other computing device for use, storage, and/or display, for example.

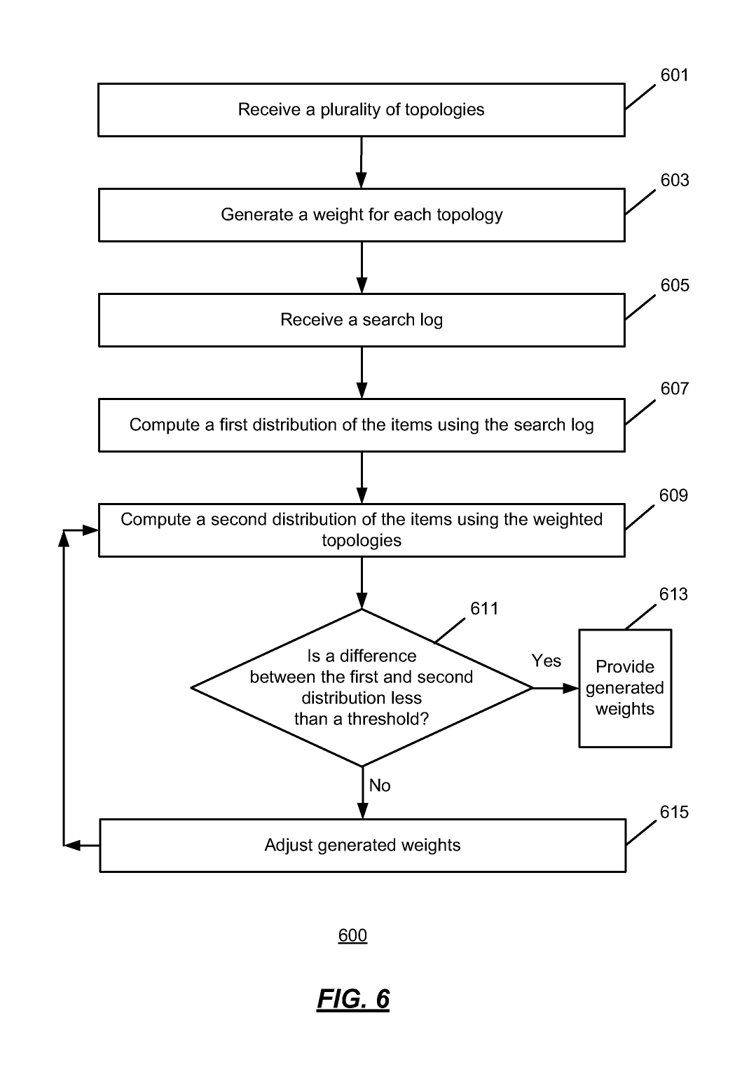

FIG. 6 is an operational flow of an implementation of a method 600 for generating weights for a plurality of topologies. The method 600 may be implemented by the weight generator 410 of the ranker 160.

A plurality of topologies is received at 601. The plurality of topologies may be received by the weight generator 410 of the ranker 160 from the topology storage 175. In some implementations, the plurality of topologies may be received from the topology generator 430 of the ranker 160. Each topology may correspond to a feature of a plurality of items. The plurality of items may be related items and may be of the same item type or category. For example, the items of the plurality of items may be televisions, and each topology may correspond to a television feature.

A weight is generated for each topology at 603. The weights may be generated by the weight generator 410 of the ranker 160. The generated weights may be estimated weights. The weight for each topology may represent the importance of the feature corresponding to the topology relative to the other features associated with the items.

A search log is received at 605. The search log 145 may be received from a search engien 140 by the weight generator 410. The search log 145 may include queries related to the items and indicators of items selected from a results set presented in response to each query. The identifiers of items selected may be clicks or click data (e.g., number of clicks), for example.

A first distribution of the items is computed at 607. The first distribution may be computed by the weight generator 410 of the ranker 160. The first distribution may be a distribution of the items based on the indicators of items selected (i.e., clicks) in the search log 145.

A second distribution of the items is computed at 609. The second distribution may be computed by the weight generator 410 of the ranker 160. The second distribution may be a stationary distribution of the items in the weighted topologies. In some implementations, the stationary distribution may be computed using single random walks of the weighted topologies.

A determination is made as to whether a difference between the first and the second distributions is less than a threshold difference at 611. The determination may be made by the weight generator 410 of the ranker 160. In some implementations, the threshold difference may be set by a user or administrator. Any method or technique for determining the difference between distributions may be used. If the determined difference is less than the threshold distance, then the method 600 may continue at 613. Otherwise, the method 600 may continue at 615.

The generated weights are provided 613. The generated weights may be provided by the weight generator 410 of the ranker 160 to the weight storage 165, for example, or other computing device.

The generated weights are adjusted at 615. The generated weights may be adjusted by the weight generator 410 of the ranker 160. The generated weights may be adjusted so that the second distribution will be closer to the first distribution. In some implementations, the weights may be adjusted by solving an optimization problem using a fundamental matrix. Other methods may also be used such as increasing or decreasing weights by a predetermined amount, or by randomly adjusting one or more of the weights.

After the weights are adjusted, the method 600 may return to 609 where the second distribution is recomputed with the adjusted weights. The difference between the first and second distributions may then be re-determined. The method 600 may continue to adjust the weights and re-determine the difference between the first and second distributions until the difference between the first and second distributions is below the threshold difference.

FIG. 7 shows an exemplary computing environment in which example embodiments and aspects may be implemented. The computing system environment is only one example of a suitable computing environment and is not intended to suggest any limitation as to the scope of use or functionality.

Numerous other general purpose or special purpose computing system environments or configurations may be used. Examples of well known computing systems, environments, and/or configurations that may be suitable for use include, but are not limited to, personal computers, server computers, handheld or laptop devices, multiprocessor systems, microprocessor-based systems, network PCs, minicomputers, mainframe computers, embedded systems, distributed computing environments that include any of the above systems or devices, and the like.

Computer-executable instructions, such as program modules, being executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

With reference to FIG. 7, an exemplary system for implementing aspects described herein includes a computing device, such as computing device 700. In its most basic configuration, computing device 700 typically includes at least one processing unit 702 and memory 704. Depending on the exact configuration and type of computing device, memory 704 may be volatile (such as random access memory (RAM)), non-volatile (such as read-only memory (ROM), flash memory, etc.), or some combination of the two. This most basic configuration is illustrated in FIG. 7 by dashed line 706.

Computing device 700 may have additional features/functionality. For example, computing device 700 may include additional storage (removable and/or non-removable) including, but not limited to, magnetic or optical disks or tape. Such additional storage is illustrated in FIG. 7 by removable storage 708 and non-removable storage 710.

Computing device 700 typically includes a variety of computer readable media. Computer readable media can be any available media that can be accessed by computing device 700 and includes both volatile and non-volatile media, removable and non-removable media.

Computer storage media include volatile and non-volatile, and removable and non-removable media implemented in any method or technology for storage of information such as computer readable instructions, data structures, program modules or other data. Memory 704, removable storage 708, and non-removable storage 710 are all examples of computer storage media. Computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 700. Any such computer storage media may be part of computing device 700.

Computing device 700 may contain communication connection(s) 712 that allow the device to communicate with other devices. Computing device 700 may also have input device(s) 714 such as a keyboard, mouse, pen, voice input device, touch input device, etc. Output device(s) 716 such as a display, speakers, printer, etc. may also be included. All these devices are well known in the art and need not be discussed at length here.

It should be understood that the various techniques described herein may be implemented in connection with hardware or software or, where appropriate, with a combination of both. Thus, the methods and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium where, when the program code is loaded into and executed by a machine, such as a computer, the machine becomes an apparatus for practicing the presently disclosed subject matter.

Although exemplary implementations may refer to utilizing aspects of the presently disclosed subject matter in the context of one or more stand-alone computer systems, the subject matter is not so limited, but rather may be implemented in connection with any computing environment, such as a network or distributed computing environment. Still further, aspects of the presently disclosed subject matter may be implemented in or across a plurality of processing chips or devices, and storage may similarly be effected across a plurality of devices. Such devices might include personal computers, network servers, and handheld devices, for example.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A method comprising:
receiving a plurality of identifiers of items at a computing device, wherein each item is associated with a plurality of feature values, and each feature value is associated with a feature of a plurality of features;
generating a plurality of topologies by the computing device, wherein each topology corresponds to a feature of the plurality of features, and each topology comprises transition probabilities between items for the feature values associated with the feature corresponding to the topology, and wherein the transition probability between a first item and a second item of a topology represents a probability that a preference for the first item will change to a preference for the second item based on the feature corresponding to the topology;
retrieving a weight for each of the generated topologies by the computing device;
ranking the plurality of identifiers of items by the computing device using the generated plurality of topologies and the retrieved weights; and
providing the ranked plurality of identifiers of items by the computing device.

2. The method of claim 1, wherein the plurality of identifiers of items comprise search results.

3. The method of claim 1, wherein the items comprise consumer products.

4. The method of claim 1, wherein the identified items are a subset of a set of items, and further wherein each topology comprises a node corresponding to each item in the set of items and a plurality of directed edges between the nodes representing the transition probabilities between the items corresponding to the nodes for the feature corresponding to the topology.

5. The method of claim 4, further comprising:
determining items from the set of items that are not identified by the identifiers of items;
removing nodes and directed edges from each topology corresponding to the determined items; and
normalizing the transition probabilities of the directed edges between the nodes that remain in the topologies.

6. The method of claim 5, wherein ranking the plurality of identifiers of items using the generated plurality of topologies and the retrieved weights comprises:
weighting each topology according to its corresponding weight;
computing a stationary distribution of a single random walk of the nodes of the weighted topologies; and
ranking the plurality of identifiers of items according to the computed stationary distribution.

7. The method of claim 1, wherein the weight for each topology is generated from a search log.

8. The method of claim 1, wherein the topologies are Markov chains.

9. A method comprising:
receiving a plurality of topologies at a computing device, wherein each topology corresponds to a feature of a plurality of items;
generating a weight for each topology at the computing device;
receiving a search log at the computing device, wherein the search log comprises queries and identifiers of items selected from a results set presented in response to each query;
computing a first distribution of the items selected in the search log by the computing device;
computing a second distribution of the items using the topologies and the weights associated with each topology by the computing device;
comparing the first and the second distributions by the computing device;
adjusting one or more of the generated weights based on the comparison by the computing device; and
providing the generated weights by the computing device.

10. The method of claim 9, wherein the topologies are Markov chains, and the second distribution is a stationary distribution.

11. The method of claim 9, further comprising:
receiving a plurality of identifiers of items, wherein the identified items are a subset of the plurality of items; and
ranking the plurality of identifiers of items using the plurality of topologies and the generated weights.

12. The method of claim 11, wherein the plurality of identifiers of items comprises search results.

13. The method of claim 11, wherein ranking the plurality of identifiers of items using the plurality of topologies and the generated weights comprises:
weighting each topology according to its corresponding weight;
computing a stationary distribution of a single random walk of the weighted topologies; and
ranking the plurality of identifiers of items according to the computed stationary distribution.

14. The method of claim 9, wherein generating the weights comprises estimating the weights.

15. The method of claim 9, wherein comparing the first and the second distributions comprises determining a difference between the first and the second distributions, and adjusting one or more of the generated weights based on the comparison comprises adjusting one or more of the generated weights if the difference is greater than a threshold difference.

16. A system comprising:
at least one computing device;
a search engine adapted to:
receive a query; and
generate identifiers of items in response to the query, wherein each item is associated with a plurality of features values and each feature value is associated with a feature of a plurality of features; and
a ranker adapted to:
receive the identifiers of items from the search engine;
rank the identifiers of items using a plurality of topologies and weights, wherein each topology corresponds to a feature of the plurality of features, and each topology comprises transition probabilities between items for the feature values associated with the feature corresponding to the topology, and wherein the transition probability between a first item and a second item of a topology represents a probability that a preference for the first item will change to a preference for the second item based on the feature corresponding to the topology; and
provide the ranked identifiers of items to the search engine.

17. The system of claim 16, wherein the ranker is further adapted to generate the plurality of topologies, and retrieve a weight for each of the generated topologies.

18. The system of claim 17, wherein the ranker is further adapted to receive a search log from the search engine, and to generate the weight for each of the topologies from the received search log.

19. The system of claim 17, wherein the ranker is further adapted to:
weight each topology according to its corresponding weight;
compute a stationary distribution of a single random walk of the weighted topologies; and
rank the identifiers of items according to the computed stationary distribution.

20. The system of claim 16, wherein the items comprise consumer products.
